(19) United States
(12) Patent Application Publication
(10) Pub. No.: US 2016/0294943 A1
(43) Pub. Date: Oct. 6, 2016

(54) Method to Federate Data Replication over a Communications Network

(71) Applicants: RICHARD BANISTER, VISTA, CA (US); WILLIAM DUBBERLEY, PULASKI, TN (US)

(72) Inventors: RICHARD BANISTER, VISTA, CA (US); WILLIAM DUBBERLEY, PULASKI, TN (US)

(21) Appl. No.: 14/680,046

(22) Filed: Apr. 6, 2015

(51) Int. Cl. H04L 29/08; G06F 17/30

(52) U.S. Cl. CPC H04L 67/1095; G06F 17/30424; G06F 17/30575

(57) ABSTRACT

A method and system enable acceleration of high performance data replication over an Internet connection by means of parallel processes. Scalability of data replication is enhanced both by means of parallel queries as subtasks of a main controller, and by wrapping the queries in date time stamp-bounded ranges, requesting only records falling within the specific times indicated by the date time stamp. By wrapping the queries, the number of records per pass is limited, enhancing the efficiency of each pass. The reduced number of records per pass further facilitates re-initiation of data replication upon failure, because fewer records are less burdensome for a computing system to attempt to transmit and/or receive multiple times. Also presented is a method by which a client may query a remote server for record keys, in place of full records, such that the client and server need process less data.

### FIELD OF THE INVENTION

The present invention relates to the relatedness of two or more databases that are within an electronic communications network. More particularly, the invented method relates to copying large amounts of data from one computing device to another via the Internet.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art enables the transfer of large amounts of data across the Internet between databases. The prior art fails to provide optimal systems and methods by which the data may be transferred. The querying, requesting, and transfer processes as they currently exist are frequently slow and prone to stoppage, without an effective means of recovering from data transfer stalls and/or failures. There is therefore a long-felt need to provide a method and system that provide increased efficiencies of electronic transmission of large amounts of data to remote database records.

### SUMMARY AND OBJECTS OF THE INVENTION

Towards these objects and other objects that will be made obvious in light of the present disclosure, a system and method are provided that enable transfer and replication of electronic data between communicatively coupled computing devices. The method of the present invention (hereinafter, “the invented method”) involves a first computing device querying a second computing device for a plurality of software data keys, wherein one or more software data keys may be selected based upon an initial and final date time stamp. The software data keys may be divided into query files, and subsequently replicated by means of a plurality of simultaneous replication processes involving transmission of a plurality of records from the second computing device to the first computing device.

A plurality of software data keys are provided to the first computing device by the second computing device following a data query received by the second computing device. The second computing device receives a plurality of replication process requests, wherein at least one replication process request comprises, at least in part, one or more software data keys. The second computing device engages in a replication process whereby the second computing device provides software data keys to the first computer device.

According to alternate embodiments of the invented method, an invented computational device is provided. The invented computational device (hereinafter, “invented device”) includes a memory coupled with a processor, wherein both the memory and the processor may enable a database management software; a means to determine the initial and final time date stamps; a means to submit one or more software data update query to the second computational device; a means to receive one or more software data keys from the second computational device; and the means to engage in one or more parallel replication processes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a diagram of an electronic communications network, comprising a client and a remote server, bidirectionally coupled by means of the Internet;

FIG. 2 is a flowchart of an aspect of the invented method whereby the client requests and receives keys from the remote server of FIG. 1, and subsequently replicates the keys;

FIG. 3 is a flowchart of a further aspect of the invented method whereby the server takes part in the round robin and fixed sequential replication processes;

FIGS. 4A-4B are flowcharts of a yet further aspect of the invented method whereby the client executes a round robin replication process;

FIGS. 5A-5B are flowcharts of an additional aspect of the invented method whereby the client executes a fixed-link sequential replication process;

FIG. 6 is a flowchart of a further aspect of the invented method whereby the server takes part in an incremented sequential replication process;

FIGS. 7A-7B are flowcharts of a further aspect of the invented method whereby the client executes an incremented sequential replication process;

FIG. 8 is a block diagram of the server of FIG. 1;

FIG. 9 is a block diagram of the client of FIG. 1;

FIG. 10 is a block diagram of an exemplary first key request message transmitted from the client to the server;

FIG. 11 is a block diagram of an exemplary first key-containing message transmitted from the server to the client;

FIG. 12 is a block diagram of an exemplary first key number query message transmitted from the client to the server;

FIG. 13 is a block diagram of an exemplary first key number containing message transmitted from the server to the client;

FIG. 14 is a block diagram of a first exemplary replication process;

FIG. 15 is a block diagram of an exemplary first download thread;

FIG. 16 is a block diagram of an exemplary first failure notification; and

FIG. 17 is a block diagram of an exemplary first success notification.

### DETAILED DESCRIPTION

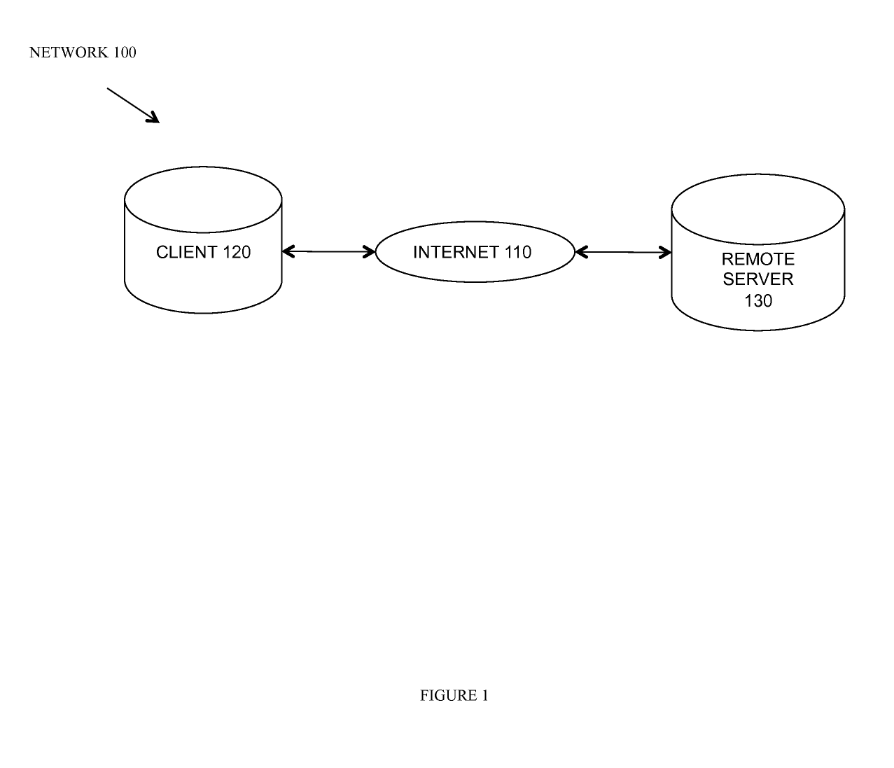

Referring now generally to the Figures and particularly to FIG. 1, FIG. 1 is a diagram of an electronic communications network 100, comprising a client 120 and a remote server 130, bidirectionally coupled by means of the Internet 110. The client 120, the remote server 130 each preferably comprise a separate database management system software, respectively a client DBMS 120A, and a remote server DBMS 130A.

The client DBMS 120A and/or the remote DBMS 130A may be or comprise an object oriented database management system (“OODBMS”) and/or a relational database management system (“RDBMS”). More particularly, the client DBMS 120A and/or the remote server DBMS 130A may be or comprise one or more prior art database management systems including, but not limited to, an ORACLE DATABASE™ database management system marketed by Oracle Corporation, of Redwood City, Calif.; a Database 2™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; and the POSTGRESQL™ open source object-relational database management system.

The remote server 130 may bi-directionally communicate and transfer data with the client 120 via the network 100 by suitable electronic communications messaging protocols and methods known in the art including, but not limited to, Simple Object Access Protocol, Representational State Transfer, and/or a webservice adapted to conform with the architecture and structure of the World Wide Web.

It is understood that the client 120 and the remote server 130 may be a software program hosted and/or enabled by, or may be or comprise a bundled computer software and hardware product such as, (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™ or WINDOWS 8™ operating system marketed by Microsoft Corporation of Redmond, Wash.; or (d.) other suitable computational system or electronic communications device known in the art capable of providing or enabling a financial web service known in the art.

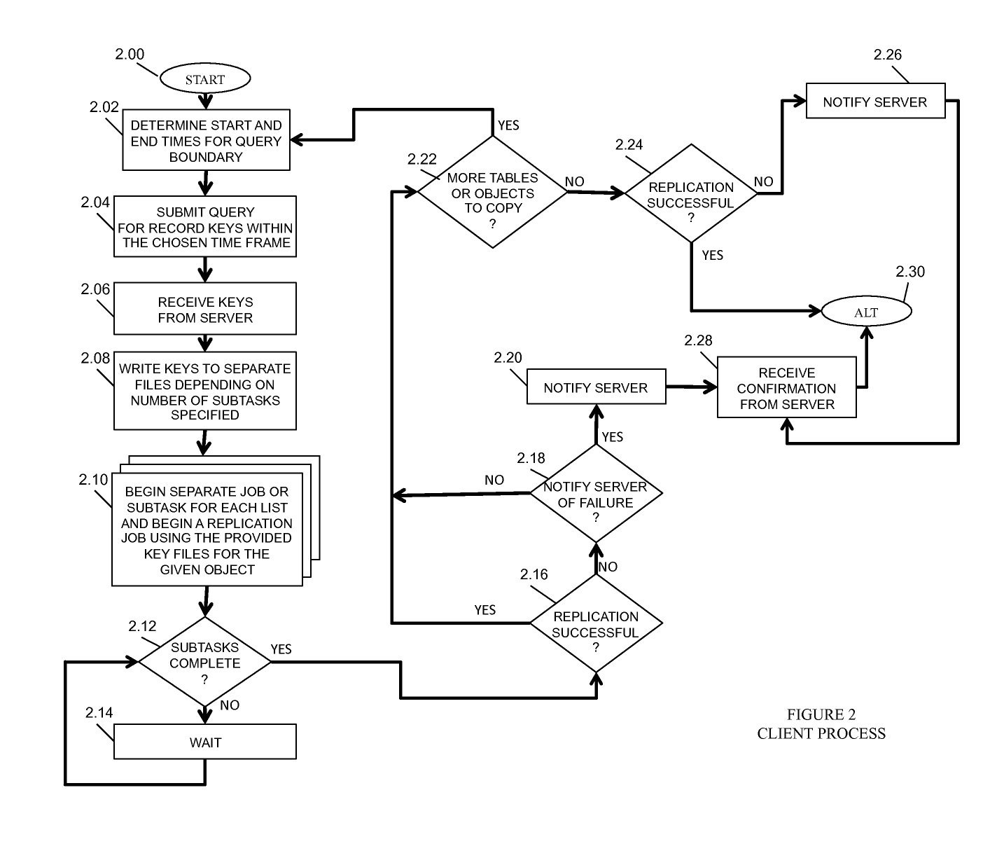

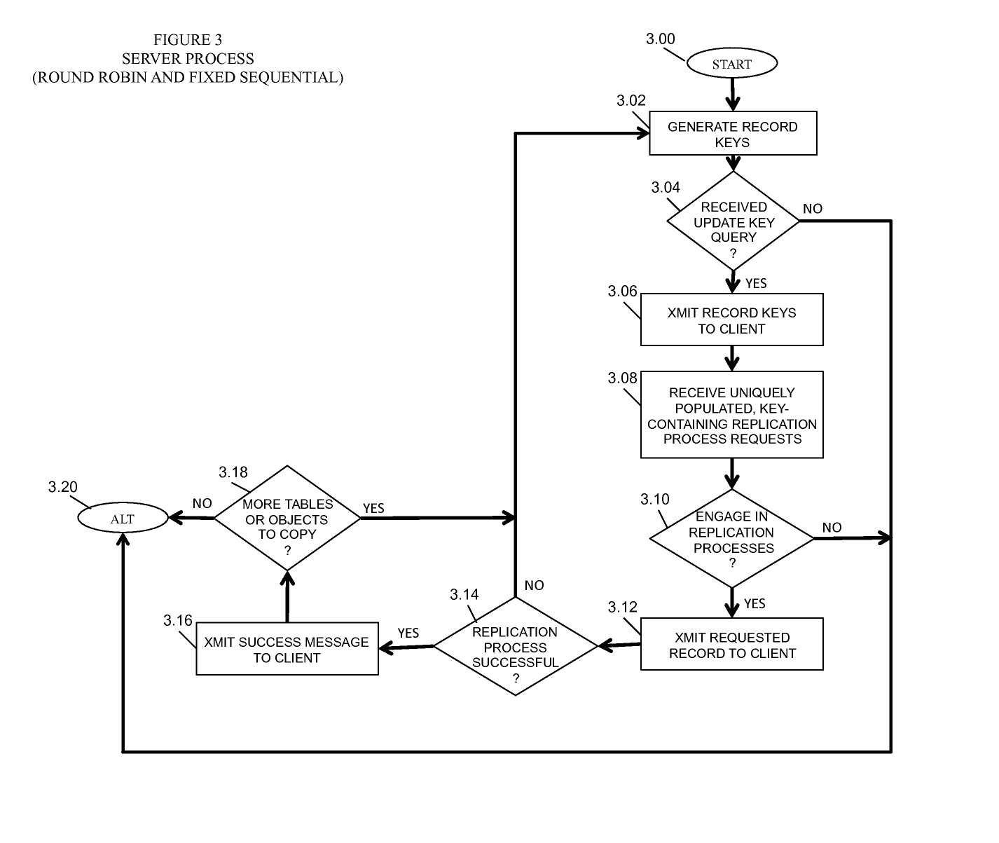

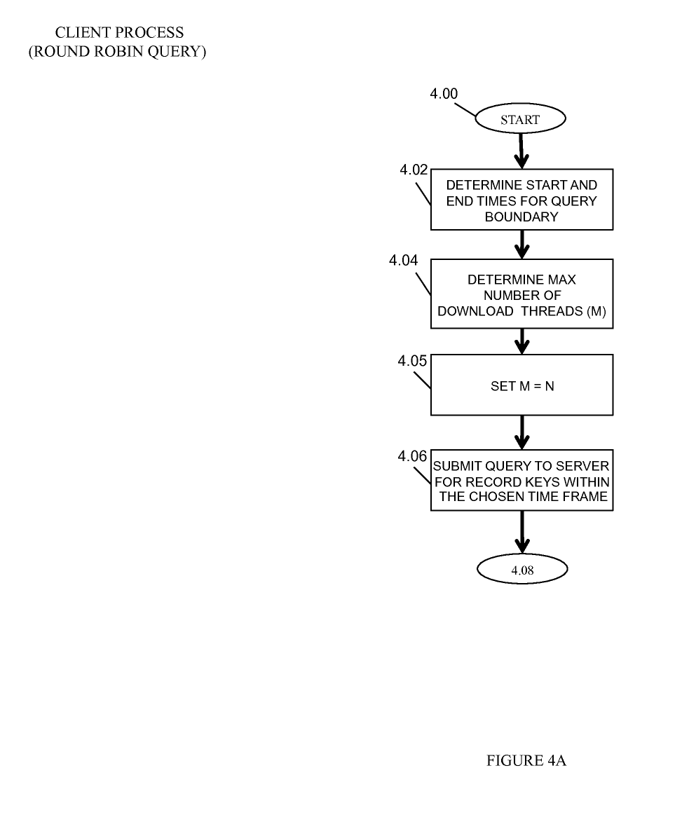

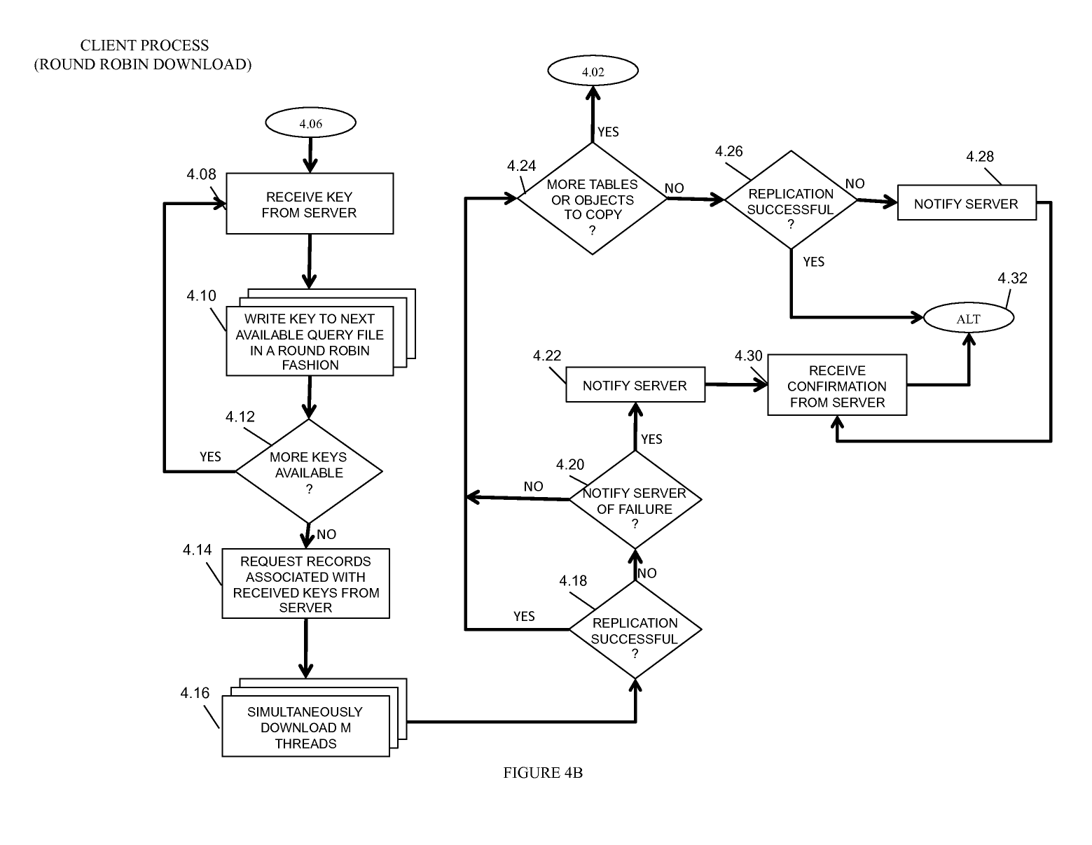

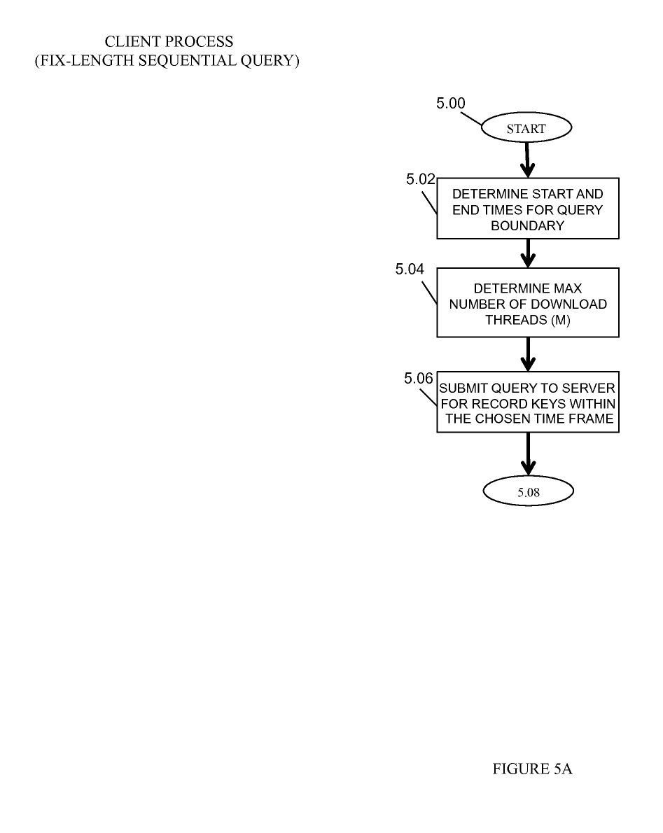

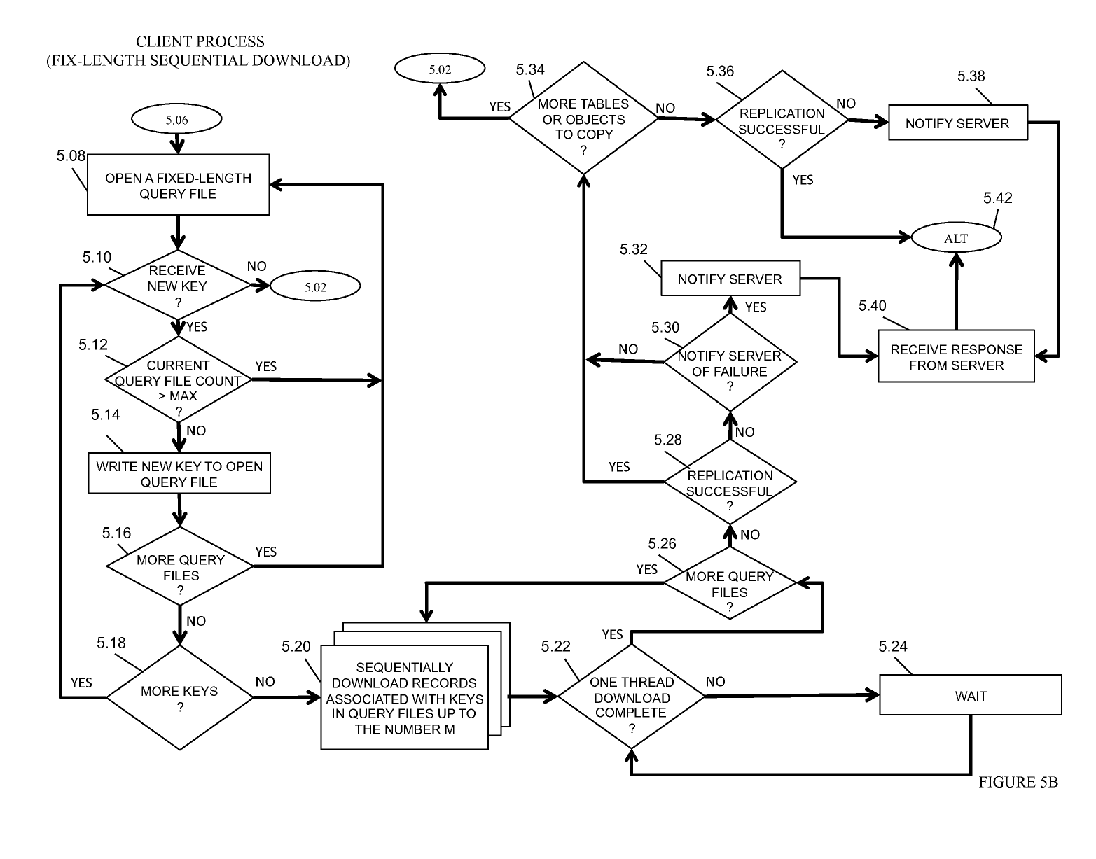

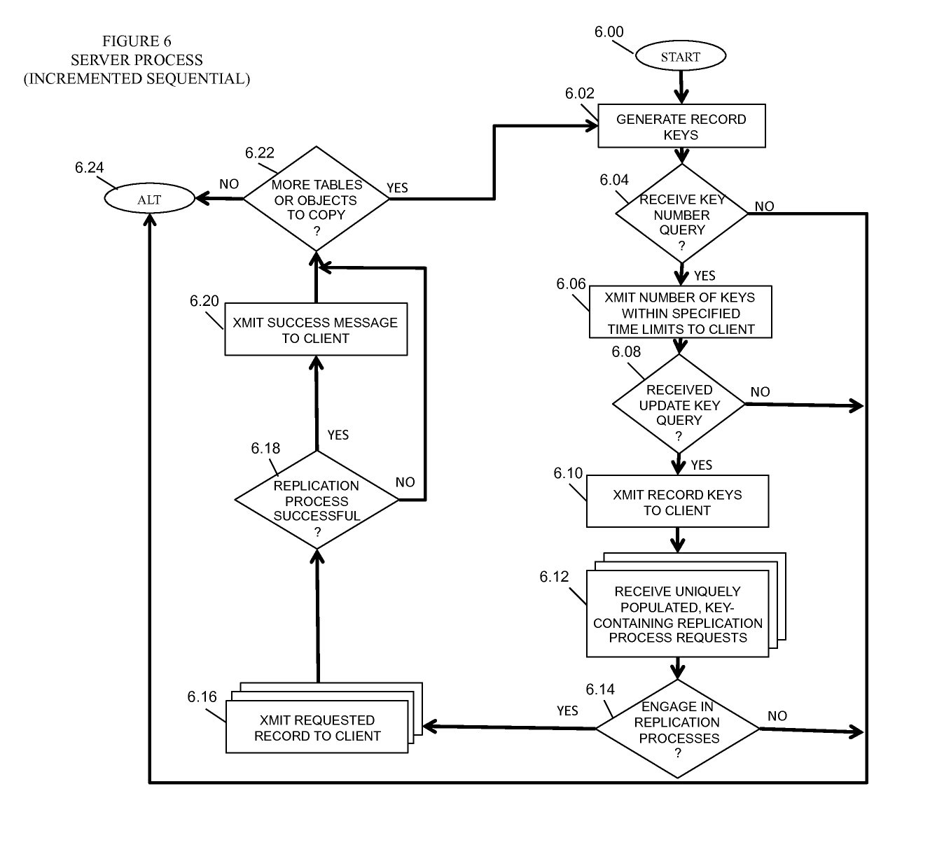

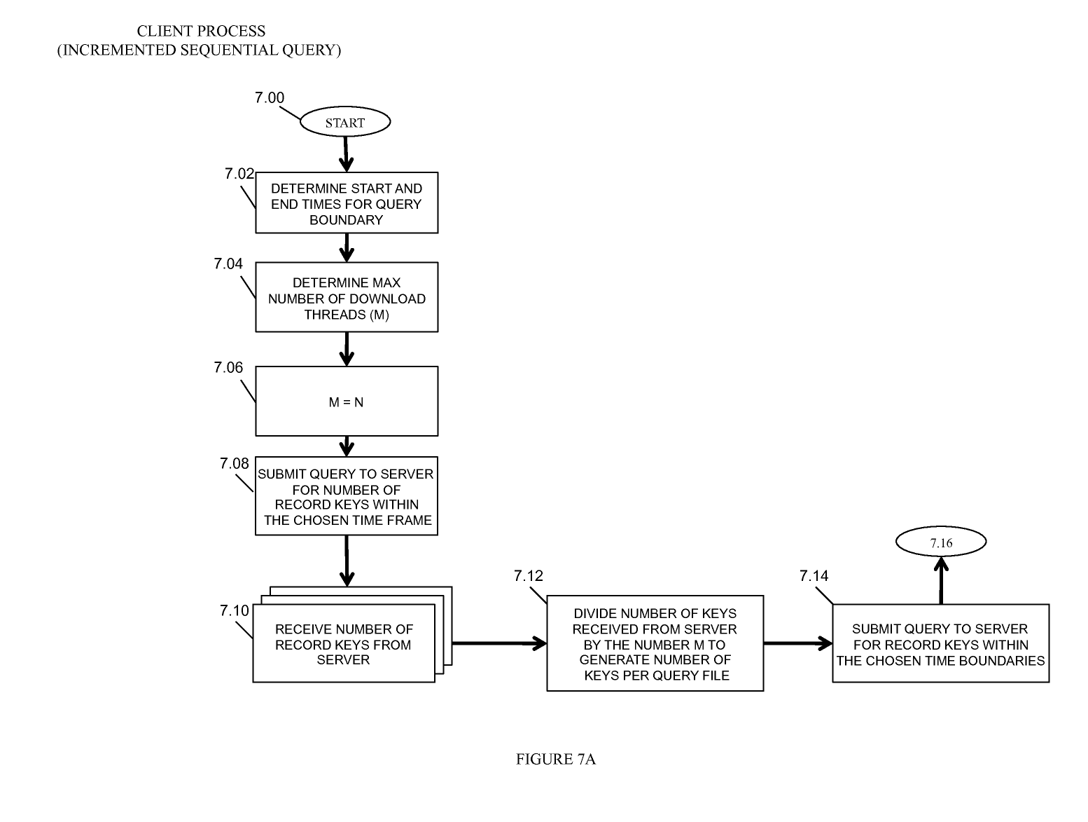

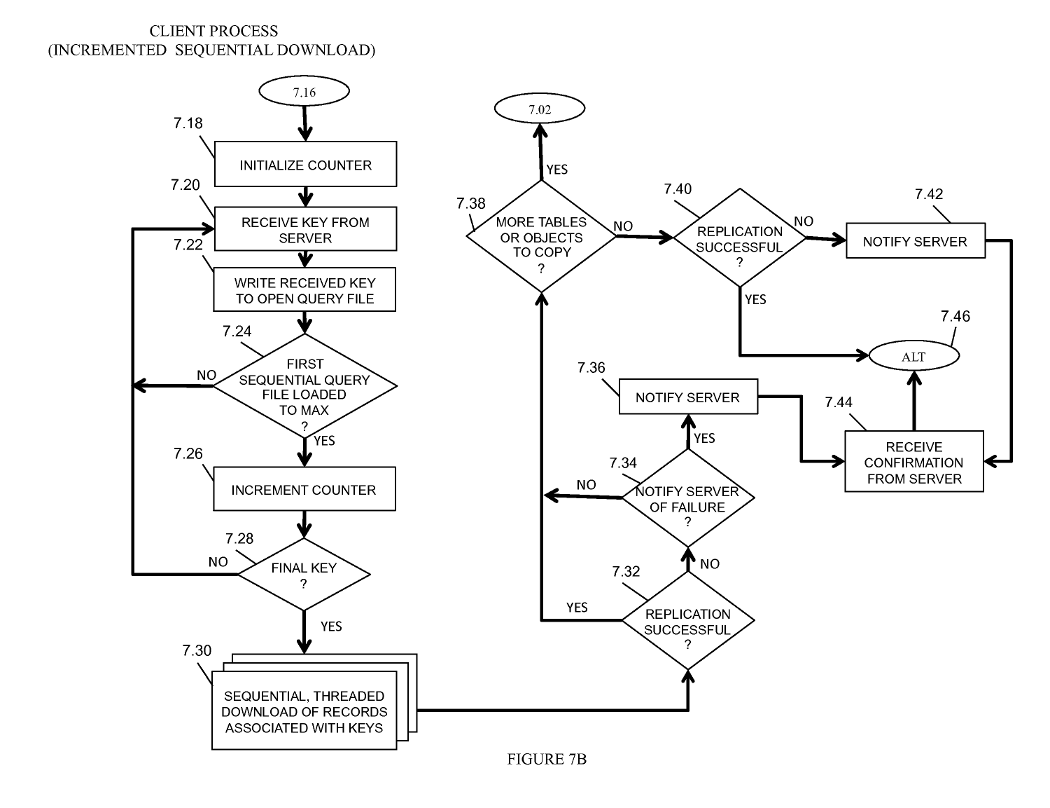

Referring now generally to the Figures, and particularly to FIG. 2, FIG. 2 is a flowchart of an aspect of the invented method whereby the client 120 requests and receives a plurality of software keys KEY.001-KEY.N from the remote server 130 of FIG. 1, and subsequently replicates the software keys KEY.001-KEY.N. The invented method comprises at least three embodiments, by which a plurality of query files QRF.001-QRF.N may be populated with software keys KEY.001-KEY.N by the client 120 and the remote server 130: a round robin process 210, an exemplary embodiment of which is discussed in FIGS. 3, 4A and 4B and accompanying text; a fixed link sequential process 220, an exemplary embodiment of which is discussed in FIGS. 3, 5A and 5B and accompanying text; and an incremented sequential process 230, an exemplary embodiment of which is discussed in FIGS. 6, 7A and 7B. The following description of FIG. 2 includes all possible methods by which the client 120 may query the remote server 130, and all possible methods by which the server 130 may transmit software keys KEY.001-KEY.N and software records REC.001-REC.N. The methods are discussed in further detail in subsequent Figures and their accompanying descriptions. In step 2.02 the client 120 specifies initial and final date time stamp query boundaries, wherein a first date time stamp T₀ represents the beginning bound of a first query QRY.001, and a second date time stamp T_{N} represents the ending bound of the first query QRY.001. In step 2.04 the client 120 submits the first query QRY.001 for the software keys KEY.001-KEY.N within date time stamp boundaries T₀-T_{N} specified in step 2.02 to the remote server 130. In step 2.06 the client 120 receives the specified software keys KEY.001-KEY.N from the remote server 130. In step 2.08 the client 120 writes the keys KEY.001-KEY.N to separate query files QRF.001-QRF.N within the client memory 120G, the number of separate query files QRF.001-QRF.N dependent on a designated number of subtasks. The number of subtasks may optionally be delineated based upon a plurality of factors, including, but not limited to, the computing capacity of the client 120 and/or the remote server 130. In step 2.10 the client 120 initiates and runs a plurality of parallel and distinct replication jobs REPL.001-REPL.N for each of the distinctly specified subtasks using the software keys KEY.001-KEY.N. In step 2.12 the client 120 determines whether the replication processes REPL.001-REPL.N have been completed for all of the designated subtasks. When the client 120 determines in step 2.12 that the replication processes REPL.001-REPL.N are not complete, the client 120 proceeds to step 2.14, wherein the client 120 waits for the replication processes REPL.001-REPL.N to be completed. The client 120 subsequently returns to step 2.12. Alternatively, when the determination in step 2.12 is positive, i.e. when the client 120 determines that all of the replication processes REPL.001-REPL.N are complete, the client 120 determines in step 2.16 whether the replication processes REPL.001-REPL.N were executed successfully. When the determination in step 2.16 is positive, the client 120 advances to step 2.22 wherein the client 120 determines whether more tables and/or objects are present which need replication. In the alternative, when the determination in step 2.16 is negative, the client 120 advances to step 2.18, wherein the client 120 determines whether to notify the remote server 130 of the failure of the replication processes REPL.001-REPL.N. When the determination to notify the remote server 130 is negative, the client 120 advances to step 2.22. Alternatively, when the determination in step 2.18 is positive, the client 120 notifies the remote server 130 of the failure of the replication processes REPL.001-REPL.N in step 2.20. In step 2.22 the client 120 determines whether more tables and/or objects are present which need replication. When the determination in step 2.22 is positive, the client 120 returns to step 2.02 and re-executes the loop of steps 2.02 through 2.22 as necessary. Alternatively, when the determination in step 2.22 is positive, the client 120 advances to step 2.24 wherein the client 120 determines again whether the replication processes REPL.001-REPL.N were successful. When the determination in step 2.24 is negative, the client 120 advances to step 2.26, wherein the client 120 notifies the server 130 of the failure of the replication processes REPL.001-REPL.N. The client 120 proceeds either from step 2.26 or from step 2.20 to step 2.28, wherein confirmation of the failure notification FL.MSG.001-FL.MSG.N is received from the remote server 130. The client 120 may proceed either from a positive determination in step 2.24 or from successful execution of step 2.28 to step 2.30, wherein alternate processes are executed.

Referring now generally to the Figures, and particularly to FIG. 3, FIG. 3 is a flowchart of a further aspect of the invented method whereby the remote server 130 takes part in an exemplary embodiment of a round robin process 210 and/or of a fixed sequential replication process 220. In step 3.02 the remote server 130 generates a plurality of software keys KEY.001-KEY.N. In step 3.04 the remote server 130 determines whether a query QRY.001 has been received for the generated software keys KEY.001-KEY.N. When the determination in step 3.04 is negative, the remote server 130 proceeds to step 3.20, wherein the server 130 executes alternate processes. In the alternative, when the determination in step 3.04 is positive, the remote server 130 advances to step 3.06, wherein the remote server 130 transmits the software keys KEY.001-KEY.N to the client 120. In step 3.08 the remote server 130 receives uniquely populated replication process requests REQ.001-REQ.N containing one or more software keys KEY.001-KEY.N. The remote server 130 determines, in step 3.10, whether to engage in the requested replication processes REPL.001-REPL.N. When the determination in step 3.10 is negative, the remote server 130 proceeds to step 3.20, wherein alternate processes are executed. Alternatively, when the determination in step 3.10 is positive, the remote server 130 transmits the requested records REC.001-REC.N associated with the software keys KEY.001-KEY.N to the client 120. In step 3.14 the remote server 130 determines whether the replication processes REPL.001-REPL.N were successful. When the determination in step 3.14 is negative, the remote server 130 proceeds to step 3.02. Alternatively, when the determination in step 3.14 is positive, the remote server 130 transmits a success message SCS.MSG.001-SCS.MSG.N to the client 120 in step 3.16. In step 3.18, the remote server 130 determines whether more tables and/or objects are present for replication. When the determination in step 3.18 is negative, the remote server 130 advances to step 3.20, wherein alternate processes are executed. In the alternative, when the determination in step 3.18 is positive, the remote server 130 proceeds to step 3.02, and re-executes the loop of steps 3.02 through 3.18 as necessary.

Referring now generally to the Figures and particularly to FIG. 4A, FIG. 4A is a flowchart of an aspect of the invented method whereby the client 120 queries the remote server 130 for a plurality of software keys KEY.001-KEY.N between time bounds designated in step 4.02. In step 4.02 the client 120 specifies initial and final date time stamp query boundaries, wherein a first date time stamp T₀ represents the beginning bound of a first query QRY.001, and a second date time stamp T_{N} represents the ending bound of the first query QRY.001. In step 4.04 the client 120 determines a maximum possible number of download threads THR.001-THR.N, represented herein by the letter “M.” In step 4.05 the client 120 designates a number “N” of query files QRF.001-QRF.N into which the requested software keys KEY.001-KEY.N may be written, and sets the maximum number of threads M equal to the number of query files QRF.001-QRF.N N. In step 4.06 the client 120 submits the first query QRY.001 for the software keys KEY.001-KEY.N within date time stamp boundaries T₀-T_{N} specified in step 4.02 to the remote server 130. The client 120 subsequently advances to step 4.08 of FIG. 4B.

Referring now generally to the Figures, and particularly to FIG. 4B, FIG. 4B is a flowchart of an aspect of the invented method whereby the client 120 populates N number of query files QRF.001-QRF.N with software keys KEY.001-KEY.N transmitted by the remote server 130, and downloads the software records REC.001-REC.N using M threads THR.001-THR.N. The client 120 proceeds from step 4.06 of FIG. 4A to step 4.08, wherein the client 120 receives a first software key KEY.001 from the remote server 130. In step 4.10 the client 120 writes the first key KEY.001 to the next available query file QRF.001-QRF.N in a round robin fashion. The round robin process 210 involves writing one software key KEY.001 to one query file QRF.001, a second software key KEY.002 to a second query file QRF.002, continuing assigning one key KEY.001-KEY.N to one query file QRF.001-QRF.N until a key KEY.001-KEY.N has been assigned to a designated final query file QRF.N. The client 120 subsequently determines in step 4.12 whether more software keys KEY.001-KEY.N are available for transfer from the remote server 130. When the determination in step 4.12 is positive, the client returns to step 4.08 and re-executes the loop of steps 4.08 through 4.12 until the determination in step 4.12 is negative. When the determination in step 4.12 is negative, the client 120 requests the software records REC.001-REC.N associated with the software keys KEY.001-KEY.N from the server 130 in step 4.14. In step 4.16 the client 120 simultaneously downloads the software records REC.001-REC.N associated with the software keys KEY.001-KEY.N which have been written to N query files QRF.001-QRF.N in M number of parallel download threads THR.001-THR.N.

In step 4.18 the client 120 determines whether the replication of the software records REC.001-REC.N was successful. When the determination in step 4.18 is negative, the client 120 determines whether to notify the remote server 130 of the failed replication REPL.001-REPL.N. When the client 120 determines in step 4.20 to notify the remote server 130 of the failure, the client 120 notifies the remote server 130 of the failure in step 4.22. Alternatively, when the determination in step 4.18 is positive, the client 120 advances to step 4.24, wherein the client 120 determines whether more tables or objects are present for replication. When the determination in step 4.24 is positive, the client 120 returns to step 4.02 of FIG. 4A. Alternatively, when the determination in step 4.24 is negative, the client 120 determines in step 4.26 whether the replication was successful. When the determination in step 4.26 is negative, the client 120 notifies the remote server 130 of the failure. The client 120 proceeds either from step 4.22 or from step 4.28 to step 4.30, wherein the client 120 receives confirmation of the failure notification FL.MSG.001-FL.MSG.N from the remote server 130. The client 120 subsequently proceeds either from the execution of step 4.30, or from a positive determination in step 4.26 to step 4.32, wherein the client 120 executes alternate processes.

Referring now generally to the Figures, and particularly to FIG. 5A, FIG. 5A is a flowchart of an additional embodiment of the invented method whereby the client 120 transmits a query QRY.001 for an example embodiment of a fix-link sequential process 220. In step 5.02 the client 120 specifies initial and final date time stamp query boundaries, wherein a first date time stamp T₀ represents the beginning bound of a first query QRY.001, and a second date time stamp T_{N} represents the ending bound of the first query QRY.001. In step 5.04 the client 120 determines a maximum possible number of download threads THR.001-THR.N, represented herein by the letter “M.” In step 5.06 the client 120 submits the first query QRY.001 for the software keys KEY.001-KEY.N within date time stamp boundaries T₀-T_{N} specified in step 5.02 to the remote server 130. The client 120 subsequently advances to step 5.08 of FIG. 5B.

Referring now generally to the Figures, and particularly to FIG. 5B, FIG. 5B is a flowchart of an additional embodiment of the invented method whereby the client 120 writes the software keys KEY.001-KEY.N to the query files QRF.001-QRF.N, and downloads the software records REC.001-REC.N associated with the software keys KEY.001-KEY.N in a series of parallel download threads THR.001-THR.N. In step 5.08 the client 120 opens a first fixed-length query file FIX.QRF.001. The fixed-length query files FIX.QRF.001-FIX.QRF.N may contain a previously designated maximum number of software keys KEY.001-KEY.N. In step 5.10 the client 120 determines whether a new software key KEY.001-KEY.N has been received. When the determination in step 5.10 is negative, the client 120 returns to step 5.02 of FIG. 5A. Alternatively, when the determination in step 5.10 is positive, the client 120 determines in step 5.12 whether the current number of software keys KEY.001-KEY.N contained in the currently open fixed-length query file FIX.QRF.001-FIX.QRF.N contains more than the designated maximum number of software keys KEY.001-KEY.N. When the determination in step 5.12 is positive, the client 120 returns to step 5.08 and opens a new fixed-length query file FIX.QRF.001-FIX.QRF.N. Alternatively, when the determination in step 5.12 is negative, the client 120 writes the new software key KEY.001-KEY.N to the open fixed-length query file FIX.QRF.001-FIX.QRF.N. In step 5.16 the client 120 determines whether more fixed-length query files FIX.QRF.001-FIX.QRF.N are present into which software keys KEY.001-KEY.N may be written are present. When the client 120 determines in step 5.16 that more fixed-length query files FIX.QRF.001-FIX.QRF.N are present, the client 120 returns to step 5.08, wherein the client 120 opens a new fixed-length query file FIX.QRF.001-FIX.QRF.N. In the alternative, when the client 120 determines that each of the possible fixed-length query files FIX.QRF.001-FIX.QRF.N contain the maximum number of software keys KEY.001-KEY.N, the client 120 determines in step 5.18 whether more software keys KEY.001-KEY.N are available for writing from the server 130. When the determination in step 5.18 is positive, the client 120 proceeds to step 5.10, wherein the client 120 repeats the loop of steps 5.10 through 5.18 until the determination in step 5.18 is negative. When the determination in step 5.18 is negative, the client 120 proceeds to step 5.20, wherein the client 120 executes a parallel download of the software records REC.001-REC.N associated with the software keys KEY.001-KEY.N in the fixed-length query files FIX.QRF.001-FIX.QRF.N in a series of download threads THR.001-THR.N up to the designated maximum number of download threads THR.001-THR.N. A number of query files QRF.001-QRF.N may exist than the maximum number of download threads THR.001-THR.N M. Accordingly, the parallel download of step 5.20 may include only the maximum number M of download threads THR.001-THR.N, but once a single download thread THR.001 has completed the replication of all of the software records REC.001-REC.N associated with the software keys KEY.001-KEY.N, a subsequent download thread THR.001 may begin. Thus, in step 5.22 the client 120 determines whether one download thread THR.001-THR.N has completed its download. When the determination in step 5.22 is negative, the client 120 waits for a download thread THR.001-THR.N to be complete in step 5.24. The client 120 subsequently repeats the loop of steps 5.22 through 5.24 until the determination in step 5.22 is positive. When the determination in step 5.22 is positive, the client 120 advances to step 5.26, wherein the client 120 determines whether more key-containing fixed-length query files FIX.QRF.001-FIX.QRF.N are present for threaded download. When the determination in step 5.26 is positive, the client 120 returns to step 5.20 wherein the client 120 executes a further parallel download of the software records REC.001-REC.N associated with the software keys KEY.001-KEY.N in the fixed-length query files FIX.QRF.001-FIX.QRF.N in a series of download threads THR.001-THR.N up to the designated maximum number of download threads THR.001-THR.N. Alternatively, when the determination in step 5.26 is negative, the client 120, in step 5.28 determines whether the replication of the software records REC.001-REC.N was successful. When the determination in step 5.26 is negative, the client 120 determines whether to notify the remote server 130 of the failed replication REPL.001-REPL.N. When the client 120 determines in step 5.28 to notify the remote server 130 of the failure, the client 120 notifies the remote server 130 of the failure in step 5.32. Alternatively, when the determination in step 5.28 is positive, the client 120 advances to step 5.34, wherein the client 120 determines whether more tables or objects are present for replication. When the determination in step 5.34 is positive, the client 120 returns to step 5.02 of FIG. 5A. Alternatively, when the determination in step 5.34 is negative, the client 120 determines in step 5.36 whether the replication was successful. When the determination in step 5.36 is negative, the client 120 notifies the remote server 130 of the failure in step 5.38. The client 120 proceeds either from step 5.32 or from step 5.38 to step 5.40, wherein the client 120 receives confirmation of the failure notification FL.MSG.001-FL.MSG.N from the remote server 130. The client 120 subsequently proceeds either from the execution of step 5.40, or from a positive determination in step 5.36 to step 5.42, wherein the client 120 executes alternate processes.

Referring now generally to the Figures, and particularly to FIG. 6, FIG. 6 is a flowchart of an additional aspect of the invented method whereby the remote server 130 takes part in exemplary embodiment of an incremented sequential process 230. In step 6.02 the remote server 130 generates a plurality of software keys KEY.001-KEY.N. In step 6.04 the remote server 130 determines whether a key number query KEY.NUM.REQ.001-KEY.NUM.REQ.N for the number of software keys KEY.001-KEY.N within a given time limit T₀-T_{N} has been received. When the determination in step 6.04 is negative, the remote server 130 executes alternate processes in step 6.24. Alternatively, when the determination in step 6.04 is positive, the remote server 130 transmits the number of keys KEY.001-KEY.N within the designated time limit T₀-T_{N} to the client 120. In step 6.08 the remote server 130 determines whether a query QRY.001 has been received for the generated software keys KEY.001-KEY.N. When the determination in step 6.08 is negative, the remote server 130 proceeds to step 6.24, wherein the server 130 executes alternate processes. In the alternative, when the determination in step 6.08 is positive, the remote server 130 advances to step 6.10, wherein the remote server 130 transmits the software keys KEY.001-KEY.N to the client 120. In step 6.12 the remote server 130 receives uniquely populated replication process requests REQ.001-REQ.N containing one or more software keys KEY.001-KEY.N. The remote server 130 determines, in step 6.14, whether to engage in the requested replication processes REPL.001-REPL.N. When the determination in step 6.14 is negative, the remote server 130 proceeds to step 6.24, wherein alternate processes are executed. Alternatively, when the determination in step 6.14 is positive, the remote server 130 transmits the requested records REC.001-REC.N associated with the software keys KEY.001-KEY.N to the client 120. In step 6.18 the remote server 130 determines whether the replication processes REPL.001-REPL.N were successful. When the determination in step 6.18 is negative, the remote server 130 proceeds to step 6.22. Alternatively, when the determination in step 6.18 is positive, the remote server 130 transmits a success message SCS.MSG.001-SCS.MSG.N to the client 120 in step 6.20. In step 6.22, the remote server 130 determines whether more tables and/or objects are present for replication. When the determination in step 6.22 is negative, the remote server 130 advances to step 6.24, wherein alternate processes are executed. In the alternative, when the determination in step 6.22 is positive, the remote server 130 proceeds to step 6.02, and re-executes the loop of steps 6.02 through 6.24 as necessary.

Referring now generally to the Figures, and particularly to FIG. 7A, FIG. 7A is a flowchart of a further embodiment of the invented method wherein the client 120 transmits a series of queries QRY.001-QRY.N in an exemplary embodiment of an incremented sequential download process 230. In step 7.02 the client 120 specifies initial and final date time stamp query boundaries, wherein a first date time stamp T₀ represents the beginning bound of a first query QRY.001, and a second date time stamp T_{N} represents the ending bound of the first query QRY.001. In step 7.04 the client 120 determines a maximum possible number of download threads THR.001-THR.N, represented herein by the letter “M.” In step 7.06 the client 120 designates a number “N” of query files QRF.001-QRF.N into which the requested software keys KEY.001-KEY.N may be written, and sets the maximum number of threads M equal to the number of query files QRF.001-QRF.N N. In step 7.08 the client 120 submits a query QRY.001 to the remote server 130 for the number of software keys KEY.001-KEY.N within the designated time limit T₀-T_{N}. In step 7.10 the client 120 receives, in a series of parallel downloads, the number of software keys KEY.001-KEY.N from the remote server 130. In step 7.12 the client divides the maximum number of download threads THR.001-THR.N M into the number of software keys received from the remote server 130 to generate the maximum number of software keys KEY.001-KEY.N per query file QRF.001-QRF.N. The number of software keys KEY.001-KEY.N per query file QRF.001-QRF.N is optimally equal, but the final query file QRF.N may contain one query file less than previous query files QRF.001-QRF.N, depending on the total number of query files QRF.001-QRF.N and the total number of software keys KEY.001-KEY.N. In step 7.14 the submits a query QRY.001-QRY.N to the remote server 130 for the software keys KEY.001-KEY.N within the chosen time boundaries. The client 120 advances to step 7.16 of FIG. 7B.

Referring now generally to the Figures, and particularly to FIG. 7B, FIG. 7B is a flowchart of an embodiment of the invented method wherein the client 120 writes software keys KEY.001-KEY.N to query files QRF.001-QRF.N and subsequently downloads the software records REC.001-REC.N associated with the software keys KEY.001-KEY.N written to the query files QRF.001-QRF.N in a threaded download scheme. In step 7.18 the client 120 initializes a query file counter 700 and sets the query file counter 700 to zero. In step 7.20 the client 120 receives the first software key KEY.001 from the remote server 130. In step 7.22 the client 120 writes the received software key KEY.001 to the first open query file QRF.001. In step 7.24 the client 120 determines whether the first sequential query file QRF.001 is loaded with the maximum number of software keys KEY.001-KEY.N as determined in step 7.14 of FIG. 7A. When the determination in step 7.26 is negative, the client 120 returns to step 7.20 and re-executes the loop of steps 7.20 through 7.24 until the determination in step 7.24 is positive. When the determination in step 7.24 is positive, the client 120 opens the subsequent query file QRF.002 and increment the query file counter 700 in step 7.26. In step 7.28 the client 120 determines whether the final key KEY.N has been received from the remote server 130. When the determination in step 7.28 is negative, the client 120 repeats the loop of steps 7.20 through 7.28 as necessary. In the alternative, when the client 120 determines in step 7.28 that the final key KEY.N has been received from the remote server 130, the client 120 advances to step 7.30. In step 7.30 executes a sequential, threaded download of the software records REC.001-REC.N associated with the software keys KEY.001-KEY.N.

In step 7.32 the client 120 determines whether the replication of the software records REC.001-REC.N was successful. When the determination in step 7.32 is negative, the client 120 determines in step 7.34 whether to notify the remote server 130 of the failed replication REPL.001-REPL.N. When the client 120 determines in step 7.34 to notify the remote server 130 of the failure, the client 120 notifies the remote server 130 of the failure in step 7.36. Alternatively, when the determination in step 7.32 is positive, the client 120 advances to step 7.38, wherein the client 120 determines whether more tables or objects are present for replication. When the determination in step 7.38 is positive, the client 120 returns to step 7.02 of FIG. 7A. Alternatively, when the determination in step 7.38 is negative, the client 120 determines in step 7.40 whether the replication was successful. When the determination in step 7.40 is negative, the client 120 notifies the remote server 130 of the failure in step 7.42. The client 120 proceeds either from step 7.36 or from step 7.42 to step 7.44, wherein the client 120 receives confirmation of the failure notification FL.MSG.001-FL.MSG.N from the remote server 130. The client 120 subsequently proceeds either from the execution of step 7.44, or from a positive determination in step 7.40 to step 7.46, wherein the client 120 executes alternate processes.

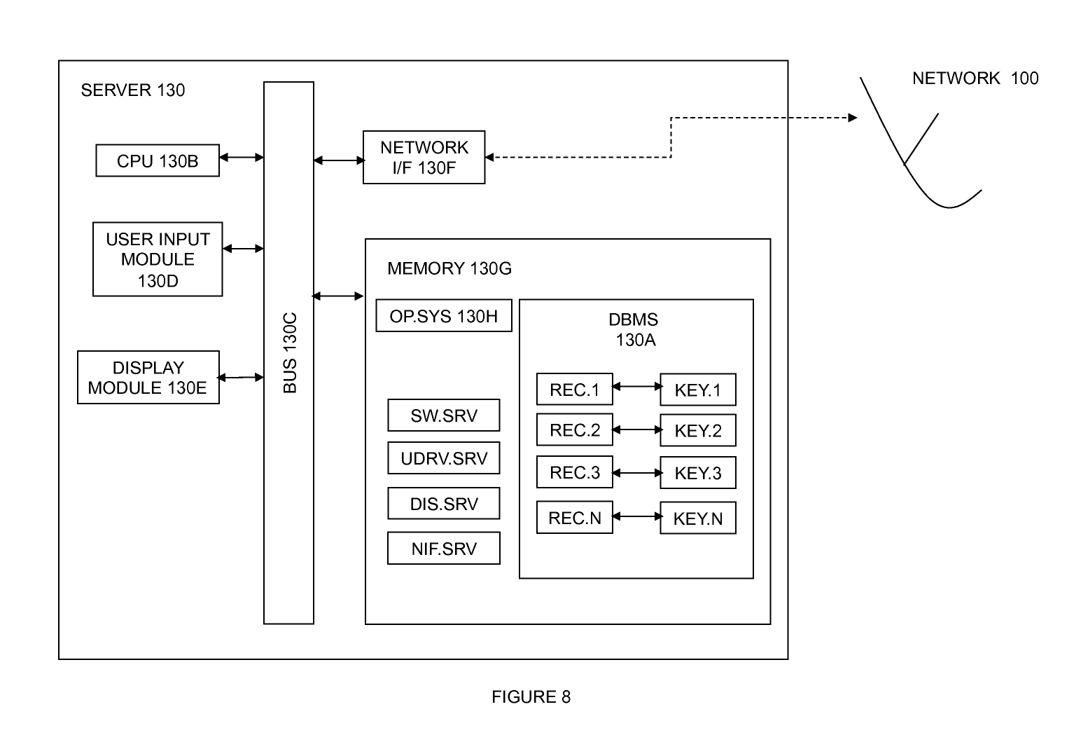

Referring now generally to the Figures, and particularly to FIG. 8, FIG. 8 is a block diagram of the remote server 130 of the network 100 of FIG. 1, wherein the remote server 130 comprises: a central processing unit (“CPU”) 130B; a user input module 130D; a display module 130E; a software bus 130C bidirectionally communicatively coupled with the CPU 130B, the user input module 130D, the display module 130E; the software bus 130C is further bidirectionally coupled with a network interface 130F, enabling communication with alternate computing devices by means of the electronic communications network 100, and a memory 130G. The software bus 130C facilitates communications between the above-mentioned components of the server 130. The memory 130G of the remote server 130 includes a software operating system OP.SYS 130H. The software OP.SYS 130H of the remote server 130 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™ or WINDOWS 8™ operating system as marketed by Microsoft Corporation of Redmond, Wash.; or the MAC OS X operating system or iPhone G4 OS™ as marketed by Apple, Inc. of Cupertino, Calif.

The remote server memory 130G further includes a server software SW.SRV, a server user input driver UDRV.SRV, a server display driver DIS.SRV, and a server network interface drive NIF.SRV. Within a server DBMS 130A are a plurality of software records REC.001, REC.002, REC.003, and REC.N. Each of the plurality of software records REC.001-REC.N within the server DBMS 130 are paired with one of a plurality of keys: KEY.001, KEY.002, KEY.003, and KEY.N, respectively. The software records REC.001-REC.N may be associated with the keys KEY.001-KEY.N for the purpose of facilitating cataloguing, searching, and modifying the software records REC.001-REC.N.

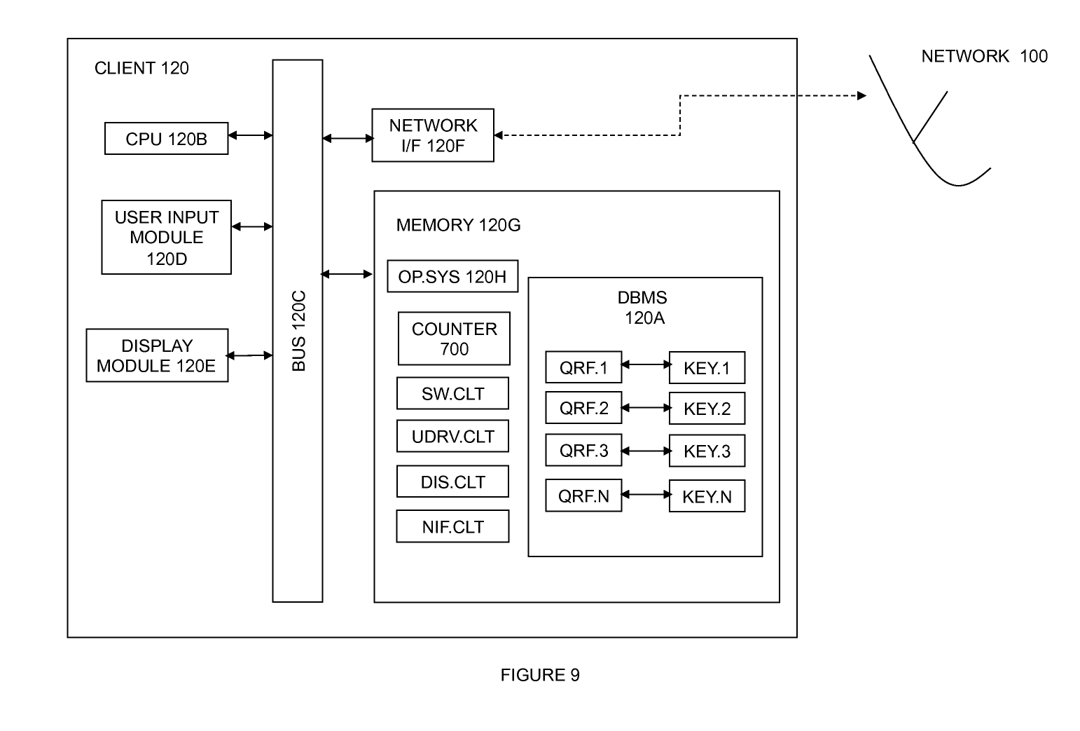

Referring now generally to the Figures, and particularly to FIG. 9, FIG. 9 is a block diagram of the client 120 of the network 100 of FIG. 1, wherein the client 120 comprises: a central processing unit (“CPU”) 120B; a user input module 120D; a display module 120E; a software bus 120C bidirectionally communicatively coupled with the CPU 120B, the user input module 120D, the display module 120E; the software bus 120C is further bidirectionally coupled with a network interface 120F, enabling communication with alternate computing devices by means of the electronic communications network 100; and a memory 120G. The software bus 120C facilitates communications between the above-mentioned components of the client 120. The memory 120G of the client 120 includes a client software operating system OP.SYS 120H. The software OP.SYS 120H of the client 120 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The memory 130G further includes a client software SW.CLT, the counter 700 of FIG. 7B, a client user input driver UDRV.CLT, a client display driver DIS.CLT, and a client network interface drive NIF.CLT. Within the client DBMS 120A are a plurality of query files QRF.001, QRF.002, QRF.003, and QRF.N. Each of the plurality of query files QRF.001-QRF.N within the server DBMS 130 are paired with one of a plurality of keys: KEY.001, KEY.002, KEY.003, and KEY.N, respectively. The association of the query files QRF.001-QRF.N with the keys KEY.001-KEY.N allows for ease of cataloguing, retrieval, and modification of the query files QRF.001-QRF.N.

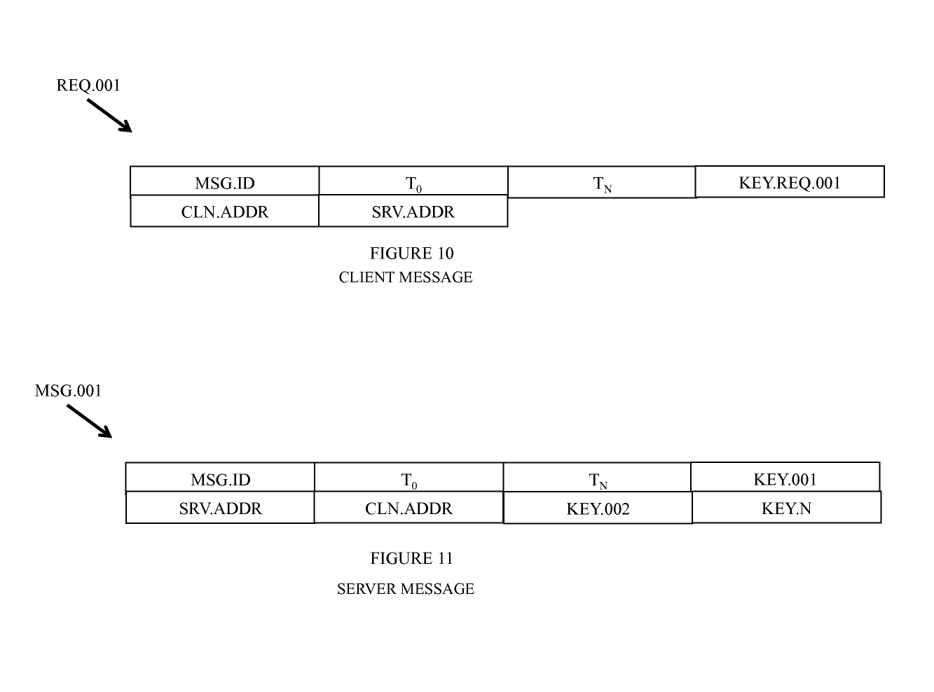

Referring now generally to the Figures and particularly to FIG. 10, FIG. 10 is a block diagram of a first query message REQ.001 transmitted from the client 120 to the remote server 130. The first query message REQ.001 includes: (a.) a unique message identifier, such that the client 120 and the remote server 130 may appropriately identify and respond to the message; (b.) a first date time stamp T₀, as a beginning time boundary for the query; (c.) a second date time stamp T_{N}, as an ending time boundary for the query; (d.) a first key request KEY.REQ.001 for the software keys KEY.001-KEY.N within the designated time boundaries; (e.) the address of the client 120 CLN.ADDR as the sending address; and (f.) the address of the remote server 130 SRV.ADDR as the recipient address.

Referring now generally to the Figures, and particularly to FIG. 11, FIG. 11 is a block diagram of a first key containing message MSG.001 transmitted from the remote server 130 to the client 120. The first key containing message MSG.001 includes: (a.) a unique message identifier, such that the client 120 and the remote server 130 may appropriately identify and respond to the message; (b.) a first date time stamp T₀, as a beginning time boundary for the query; (c.) a second date time stamp T_{N}, as an ending time boundary for the query; (d.) a plurality of software keys KEY.001-KEY.N; (e.) the address of the remote server 130 SRV.ADDR as the sending address; and (f.) the address of the client 120 CLN.ADDR as the recipient address.

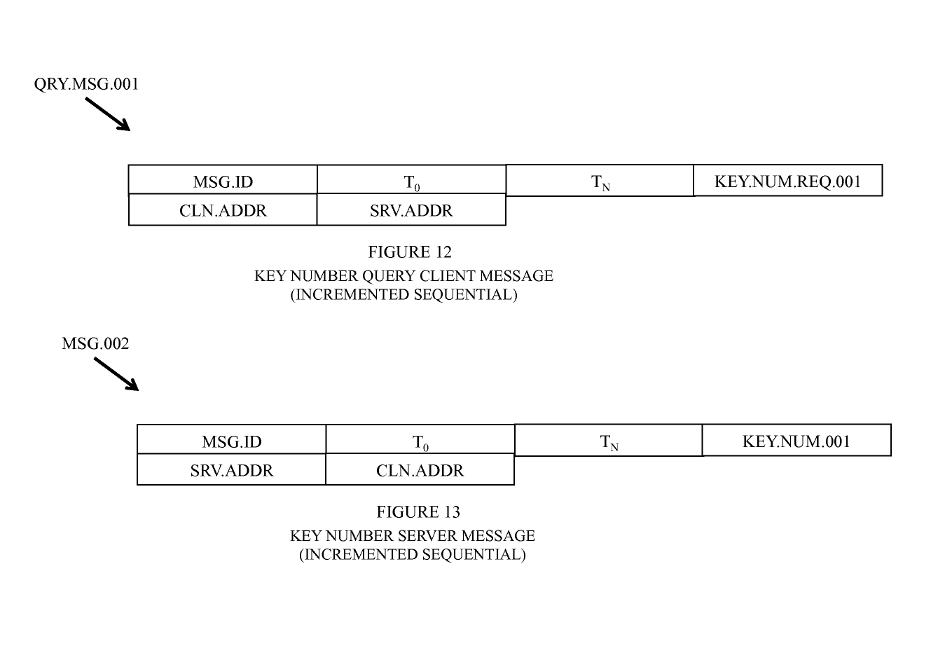

Referring now generally to the Figures, and particularly to FIG. 12, FIG. 12 is a block diagram of an exemplary first key number query message QRY.MSG.001 transmitted from the client 120 to the server 130. The first key number query message QRY.MSG.001 includes: (a.) a unique message identifier, such that the client 120 and the remote server 130 may appropriately identify and respond to the message; (b.) a first date time stamp T₀, as a beginning time boundary for the query; (c.) a second date time stamp T_{N}, as an ending time boundary for the query; (d.) a first key number request KEY.NUM.REQ.001 for the software keys KEY.001-KEY.N within the designated time boundaries; (e.) the address of the client 120 CLN.ADDR as the sending address; and (f.) the address of the remote server 130 SRV.ADDR as the recipient address.

Referring now generally to the Figures and particularly to FIG. 13, FIG. 13 is a block diagram of an exemplary first key number containing message MSG.002, transmitted from the remote server 130 to the client 120. The first key number containing message MSG.002 includes: (a.) a unique message identifier MSG.ID, such that the client 120 and the remote server 130 may appropriately identify and respond to the message; (b.) a first date time stamp T₀, as a beginning time boundary for the query; (c.) a second date time stamp T_{N}, as an ending time boundary for the query; (d.) a number of keys KEY.NUM.001; (e.) the address of the remote server 130 SRV.ADDR as the sending address; and (f.) the address of the client 120 CLN.ADDR as the recipient address.

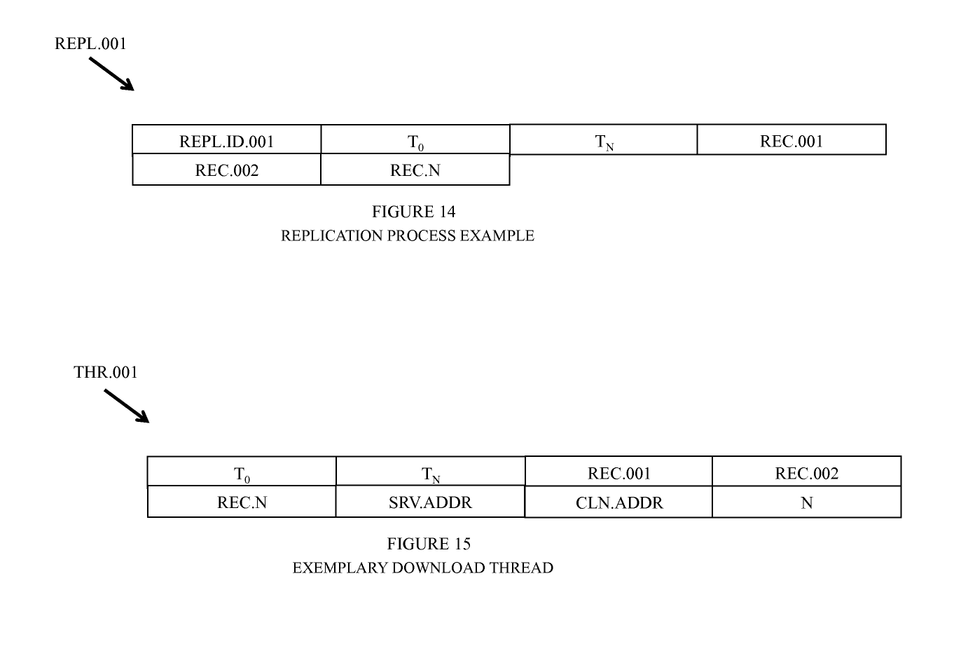

Referring now generally to the Figures and particularly to FIG. 14, FIG. 14 is a block diagram of an exemplary first replication process REPL.001. The first replication process REPL.001 includes: (a.) a unique replication process identifier REPL.ID.001, such that the client 120 and the remote server 130 may appropriately identify and respond to the message; (b.) a first date time stamp T₀, as a beginning time boundary for the query; (c.) a second date time stamp T_{N}, as an ending time boundary for the query; and (d.) a plurality of software records REC.001-REC.N.

Referring now generally to the Figures and particularly to FIG. 15, FIG. 15 is a block diagram of an exemplary first download thread THR.001. The first download thread THR001 includes: (a.) a first date time stamp T₀, as a beginning time boundary for the query; (b.) a second date time stamp T_{N}, as an ending time boundary for the query; (c.) a plurality of software records REC.001-REC.N; (d.) the address of the remote server 130 SRV.ADDR as the sending address; (e.) the address of the client 120 CLN.ADDR as the recipient address; and (f.) the number N of maximum number of records REC.001-REC.N per thread THR.001.

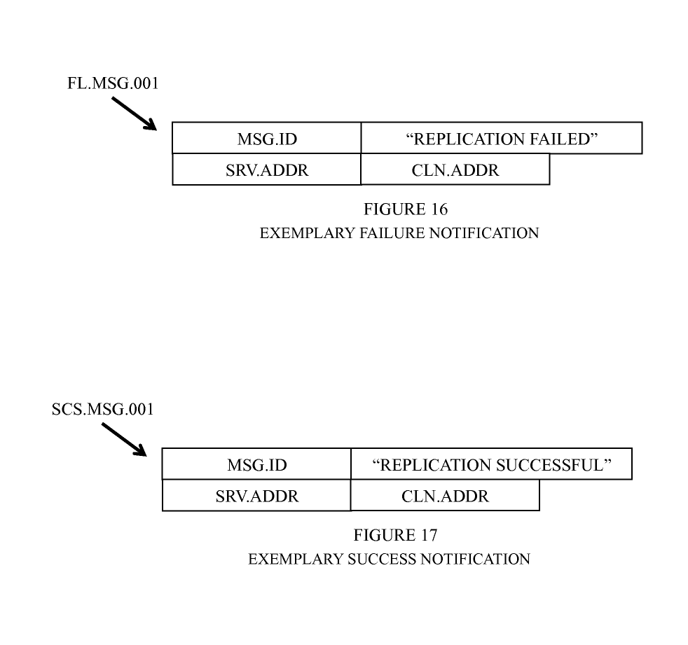

Referring now generally to the Figures and particularly to FIG. 16, FIG. 16 is a block diagram of an exemplary first failure notification FL.MSG.001. The first failure notification FL.MSG.001 includes: (a.) a unique failure message FL.MSG.001 identifier MSG.001, such that the client 120 and the remote server 130 may appropriately identify and respond to the failure message FL.MSG.001 (b.) a string of text or other communicative means indicating the failure of the replication process REPL.001-REPL.N; (c.) the address of the remote server 130 SRV.ADDR as the sending address; and (D.) and the address of the client 120 CLN.ADDR as the recipient address.

Referring now generally to the Figures and particularly to FIG. 17, FIG. 17 is a block diagram of an exemplary first success notification SCS.MSG.001. The first success notification SCS.MSG.001 includes: (a.) a unique success message SCS.MSG.001 identifier MSG.001, such that the client 120 and the remote server 130 may appropriately identify and respond to the success message SCS.MSG.001 (b.) a string of text or other communicative means indicating the success of the replication process REPL.001-REPL.N; (c.) the address of the remote server 130 SRV.ADDR as the sending address; and (D.) and the address of the client 120 CLN.ADDR as the recipient address.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

We claim:

1. A computer implemented method for data replication between a bi-directionally communicatively coupled server and a client, the method comprising:
a. The client determining a time bounds of a record update key query;
b. The client submitting the record update key query to the server;
c. The client receiving a plurality of record keys from the server;
d. The client distributing the individual record keys to a plurality of query files; and
e. The client initiating a plurality of replication processes, one for each query file, wherein each replication process requests a record update from the server of each record identified by the individual record keys assigned to each query file, wherein each record key is distributed to only one query file and the two or more replication processes run in parallel.

2. The method of claim 1, wherein at least one record key identifies a record of a relational database.

3. The method of claim 1, wherein at least one record key identifies a software object of an object-oriented database.

4. The method of claim 1, wherein the time bounds is at least partially derived from an initial load.

5. The method of claim 1, wherein the time bounds is at least partially derived from a most recent time that the server was queried by the client.

6. The method of claim 1, further comprising a restart of a replication process after a determination of a failure of the restarted replication process to complete receiving records referenced by record keys assigned to a same query file.

7. The method of claim 1, wherein the query files are populated with substantively approximately equal counts of record keys.

8. The method of claim 7, wherein all query files have a quantity of record keys no greater than 1 plus the average number of record keys distributed to each query file.

9. The method of claim 1, wherein the plurality of record keys are distributed in round robin fashion to the query files.

10. The method of claim 1, wherein at least one replication process is an independent job initiated by a computational thread.

11. The method of claim 1, wherein at least one replication process is a computational thread.

12. The method of claim 1, wherein the number of replication processes is determined by a client configuration.

13. A computer implemented method for data replication between a bi-directionally communicatively coupled server and a client, the method comprising:
a. The server receiving a record update key query from the client;
b. The server providing a plurality of record keys to the client;
c. The server receiving a plurality of replication process requests from the client, each replication process request including a unique plurality of record keys; and
d. The server engaging with the client in the requested plurality of replication processes, wherein each replication process includes at least one record being provided to the client in response to the record update key query received by the server from the client.

14. The method of claim 13, wherein the update key query includes a time bounds, wherein the plurality of record keys provided to the client each identify a record noted as having been updated at the server within the time bounds.

15. The method of claim 13, wherein at least two replication processes are engaged in parallel by the server.

16. The method of claim 13, wherein the server maintains a plurality of records in a database, each record comprising a unique record key.

17. The method of claim 13, wherein the server maintains a plurality of records in a database, each record associated with a unique record key.

18. The method of claim 13, further comprising a restart of a replication process after a determination of a failure of the restarted replication process.

19. The method of claim 13, wherein each replication process is populated with approximately equal counts of record keys.

20. A computer comprising:
a. a memory;
b. a processer coupled with the memory, the processor and memory adapted to enable a database management software;
c. means to determine a time bounds of a record update key query;
d. means to submit the record update key query to a server;
e. means to receive a plurality of record keys from the server;
f. means to distribute the individual record keys to a plurality of query files; and
g. means to initiate a plurality of replication processes, one for each query file, wherein each replication process requests a record update from the server of each record identified by the individual record keys assigned to each query file, wherein each record key is distributed to only one query file and the two or more replication processes run in parallel.
